(19) United States
(12) Patent Application Publication
(10) Pub. No.: US 2023/0213706 A1
(43) Pub. Date: Jul. 6, 2023

(54) HOUSING FOR AN OPTICAL FIBER CONNECTOR THAT RELEASES FROM A RECEPTACLE IN RESPONSE TO A PULLING FORCE

(71) Applicant: PPC BROADBAND, INC., East Syracuse, NY (US)

(72) Inventors: Kim LEESON, Ipswich (GB); Shaun TREZISE, Aldeburgh (GB)

(73) Assignee: PPC BROADBAND, INC., East Syracuse, NY (US)

(21) Appl. No.: 18/092,107

(22) Filed: Dec. 30, 2022

Related U.S. Application Data
(60) Provisional application No. 63/295,445, filed on Dec. 30, 2021.

(51) Int. Cl. G02B 6/38

(52) U.S. Cl. CPC G02B 6/3831

(57) ABSTRACT

A housing for an optical fiber connector may include a body portion that may be configured to be received by an optical fiber receptacle and a latching portion that may be configured to extend from the body portion proximate a first end of the body portion. The body portion and the latching portion also may be configured to be slidingly received in an optical fiber receptacle via a first end of the receptacle. The latching portion further may be configured to be urged toward the body portion by the receptacle in response to a predetermined pulling force applied to the housing in a direction away from the first end of the receptacle to de-latch the housing from the receptacle such that the housing is slidingly removed from the receptacle without manually operating the latching portion so as to prevent damage to the connector, the receptacle, and/or a fiber terminated by the connector.

### CROSS-REFERENCE TO RELATED APPLICATION

This application claims the benefit of U.S. Provisional Application No. 63/295,445, filed Dec. 30, 2021, pending, the disclosure of which is hereby incorporated by reference herein in its entirety.

### BACKGROUND

The present disclosure generally relates to connectors deploying a release from a receptacle, and more specifically to Lucent Connector (LC) duplex adapters and narrow width multi-fiber connectors

The prevalence of the Internet has led to unprecedented growth in communication networks. Consumer demand for service and increased competition has caused network providers to continuously find ways to improve quality of service while reducing cost.

Certain solutions have included deployment of high-density interconnect panels. High-density interconnect panels may be designed to consolidate the increasing volume of interconnections necessary to support the fast-growing networks into a compacted form factor, thereby increasing quality of service and decreasing costs such as floor space and support overhead.

FIG. 10 depicts a housing for a conventional optical fiber connector, particularly, an LC connector. The housing 800 includes a latch portion 850 extending from a body portion 820 adjacent a front end 824 of the housing 800 and configured to latch the housing 800 to an optical fiber receptacle (not shown). The housing 800 is latched to the receptacle with a latch surface 864 secured behind a surface of a cutout (not shown) in the receptacle. The latch portion 850 must be urged toward the body portion by manually applying a force at or near a free end 858 of the latch portion 850 to release the latch portion 850, and thus the housing 800, from the receptacle. Therefore, when a cable for a conventional LC connector is inadvertently pulled away from the port in a rearward direction, damage could occur to the cable, the port, and/or the connector given that the conventional LC connector will not disengage from the receptacle unless a user depresses the latch portion 850.

Therefore, in order to avoid permanent damage to the cable and connector assembly, it may be desirable to provide a housing for an optical fiber connector that is configured to release from a receptacle in response to a predetermined pulling force and without manual operation so as to prevent damage to the connector, the receptacle, and/or a fiber terminated by the connector.

### SUMMARY

According to various embodiments of the disclosure, a housing for an optical fiber connector includes a body portion configured to be received by an optical fiber receptacle and a latching portion configured to extend from a wall of the body portion proximate a first end of the body portion. The latching portion includes a first portion that is configured to extend substantially perpendicularly from the wall of the body, a second portion that is configured to extend in a longitudinal direction from the first end of the body portion toward the second end of the body portion, and a third portion that connects the first portion and the second portion. The third portion comprises a bend portion that is configured to include a notched portion at an inside of a bend of the bend portion, and the second portion is configured to extend from the third portion and terminates at a free end. The latching portion is configured to flex relative to the body portion in directions toward and away from the body portion, and a flexibility of the latching portion relative to the body portion is configured to be proportional to a size of the notched portion. The second end of the body portion is configured to be slidingly received in a receiving portion of an optical fiber receptacle via a first end of the receptacle, and the free end of the latching portion is configured to contact an inner surface of a wall of the receptacle and to be urged toward the body portion by the inner surface of the wall such that the latching portion is configured to be slidingly received in the receiving portion of the receptacle. The second portion of the latching portion includes an engagement portion configured to engage an engagement feature of the receiving portion of the receptacle to latch the housing to the receptacle, the engagement portion is configured to include an engagement surface that is configured to face in a first direction toward the first end of the body portion and toward an engagement surface of the engagement feature that is configured to face in a second direction opposite to the first direction, and the engagement surface is configured to form an angle relative to an axis that is perpendicular to the wall of the body portion. The engagement surface is configured to be urged toward the body portion by the engagement feature in response to a predetermined pulling force applied to the housing in a direction away from the first end of the receptacle to de-latch the housing from the receptacle such that the housing is slidingly removed from the receptacle without manually operating the latching portion so as to prevent damage to the connector, the receptacle, and/or a fiber terminated by the connector, and the predetermined pulling force required for the engagement surface to be urged toward the body portion by the engagement feature is inversely proportional to the relative flexibility between the latching portion and the body portion and to the angle formed by the engagement surface.

According to various aspects of the above embodiment, the predetermined pulling force is 5 N or greater and the angle is 15° or greater.

According to various aspects of any of the above embodiments, the predetermined pulling force is 20 N or greater and the angle is 0° or greater.

According to various aspects of any of the above embodiments, the predetermined pulling force is 50 N or greater.

According to various embodiments of the disclosure, a housing for an optical fiber connector includes a body portion configured to be received by an optical fiber receptacle and a latching portion configured to extend from a wall of the body portion proximate a first end of the body portion. The latching portion includes a first portion that is configured to extend substantially perpendicularly from the wall of the body, a second portion that is configured to extend in a longitudinal direction from the first end of the body portion toward a second end of the body portion, and a third portion that connects the first portion and the second portion. The latching portion is configured to flex relative to the body portion in directions toward and away from the body portion, the second end of the body portion is configured to be slidingly received in a receiving portion of an optical fiber receptacle via a first end of the receptacle, the latching portion is configured to be urged toward the body portion by the receiving portion such that the latching portion is configured to be slidingly received in the receiving portion of the receptacle, and the second portion of the latching portion includes an engagement portion configured to engage an engagement feature of the receiving portion of the receptacle to latch the housing to the receptacle. The engagement portion is configured to be urged toward the body portion by the engagement feature in response to a predetermined pulling force applied to the housing in a direction away from the first end of the receptacle to de-latch the housing from the receptacle such that the housing is slidingly removed from the receptacle without manually operating the latching portion so as to prevent damage to the connector, the receptacle, and/or a fiber terminated by the connector.

According to various aspects of any of the above embodiments, the third portion comprises a bend portion that is configured to include a notched portion at an inside of a bend of the bend portion.

According to various aspects of any of the above embodiments, a flexibility of the latching portion relative to the body portion is configured to be proportional to a size of the notched portion.

According to various aspects of any of the above embodiments, the predetermined pulling force required for the engagement surface to be urged toward the body portion by the engagement feature is inversely proportional to the relative flexibility between the latching portion and the body portion.

According to various aspects of any of the above embodiments, the engagement portion is configured to include an engagement surface that is configured to face in a first direction toward the first end of the body portion and toward an engagement surface of the engagement feature that is configured to face in a second direction opposite to the first direction.

According to various aspects of any of the above embodiments, the engagement surface is configured to form an angle relative to an axis that is perpendicular to the wall of the body portion.

According to various aspects of any of the above embodiments, the predetermined pulling force required for the engagement surface to be urged toward the body portion by the engagement feature is inversely proportional to the angle formed by the engagement surface.

According to various aspects of any of the above embodiments, the second portion is configured to extend from the third portion and terminates at a free end.

According to various aspects of any of the above embodiments, the free end of the latching portion is configured to be urged toward the body portion by the inner surface of the receiving portion such that the latching portion is configured to be slidingly received in the receiving portion of the receptacle.

According to various aspects of any of the above embodiments, the predetermined pulling force is 5 N or greater and the angle is 15° or greater.

According to various aspects of any of the above embodiments, the predetermined puffing force is 20 N or greater and the angle is 0° or greater.

According to various aspects of any of the above embodiments, the predetermined pulling force is 50 N or greater.

According to various embodiments of the disclosure, a housing for an optical fiber connector includes a body portion configured to be received by an optical fiber receptacle and a latching portion configured to extend from the body portion proximate a first end of the body portion. The body portion and the latching portion are configured to be slidingly received in an optical fiber receptacle via a first end of the receptacle. The latching portion is configured to be urged toward the body portion by the receptacle in response to a predetermined pulling force applied to the housing in a direction away from the first end of the receptacle to de-latch the housing from the receptacle such that the housing is slidingly removed from the receptacle without manually operating the latching portion so as to prevent damage to the connector, the receptacle, and/or a fiber terminated by the connector.

According to various aspects of any of the above embodiments, the latching portion is configured to flex relative to the body portion in directions toward and away from the body portion,

According to various aspects of any of the above embodiments, the latching portion includes a first portion that is configured to extend substantially perpendicularly from the wall of the body, a second portion that is configured to extend in a longitudinal direction from the first end of the body portion toward a second end of the body portion, and a third portion that connects the first portion and the second portion.

According to various aspects of any of the above embodiments, the third portion comprises a bend portion that is configured to include a notched portion at an inside of a bend of the bend portion,

According to various aspects of any of the above embodiments, a flexibility of the latching portion relative to the body portion is configured to be proportional to a size of the notched portion.

According to various aspects of any of the above embodiments, the predetermined pulling force required for the latching portion to be urged toward the body portion is inversely proportional to the relative flexibility between the latching portion and the body portion.

According to various aspects of any of the above embodiments, the latching portion includes an engagement portion configured to engage an engagement feature of the receiving portion of the receptacle to latch the housing to the receptacle.

According to various aspects of any of the above embodiments, the engagement portion is configured to include an engagement surface that is configured to face in a first direction toward the first end of the body portion and toward an engagement surface of the engagement feature that is configured to face in a second direction opposite to the first direction.

According to various aspects of any of the above embodiments, the engagement surface is configured to form an angle relative to an axis that is perpendicular to the wall of the body portion.

According to various aspects of any of the above embodiments, the predetermined pulling force required for the engagement surface to be urged toward the body portion by the engagement feature is inversely proportional to the angle formed by the engagement surface.

According to various aspects of any of the above embodiments, the latching portion is configured to be urged toward the body portion by a receiving portion of the receptacle such that the latching portion is configured to be slidingly received in the receiving portion of the receptacle.

According to various aspects of any of the above embodiments, the second portion is configured to extend from the third portion and terminates at a free end.

According to various aspects of any of the above embodiments, the free end of the latching portion is configured to be urged toward the body portion by the inner surface of the receiving portion such that the latching portion is configured to be slidingly received in the receiving portion of the receptacle.

According to various aspects of any of the above embodiments, the predetermined pulling force is 5 N or greater and the angle is 15° or greater.

According to various aspects of any of the above embodiments, the predetermined pulling force is 20 N or greater and the angle is 0° or greater.

According to various aspects of any of the above embodiments, the predetermined pulling force is 50 N or greater.

### BRIEF DESCRIPTION OF THE DRAWINGS

Further advantages and features of the present disclosure will become apparent from the following description and the accompanying drawings, to which reference is made. In which are shown:

FIG. 1 is a perspective view of an exemplary optical fiber connector in accordance with various aspects of the disclosure.

FIG. 2 is a side view of the optical fiber connector of FIG. 1.

FIG. 3 is an enlarged perspective view of a latch portion of the optical fiber connector of FIG. 1.

FIG. 4 is an end view of the optical fiber connector of FIG. 1.

FIG. 5 is a side cross sectional view of the connector of FIG. 1 in a receptacle taken along line V-V of FIG. 4.

Fla 6 is a side cross sectional view of the connector of FIG. 1 in a receptacle taken along line VI-VI of FIG. 4.

FIG. 7 is perspective cross sectional view of the connector of FIG. 1 in a receptacle taken along line V-V of FIG. 4.

FIG. 8 is an end view of the connector of FIG. 1 in a receptacle.

FIG. 9 is a perspective view of another exemplary optical fiber connector in accordance with various aspects of the disclosure.

FIG. 16 is a &de view of a conventional optical fiber connector.

### DETAILED DESCRIPTION

Reference will now be made in detail to presently preferred embodiments and methods of the present disclosure, which constitute the best modes of practicing the present disclosure presently known to the inventors. It is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

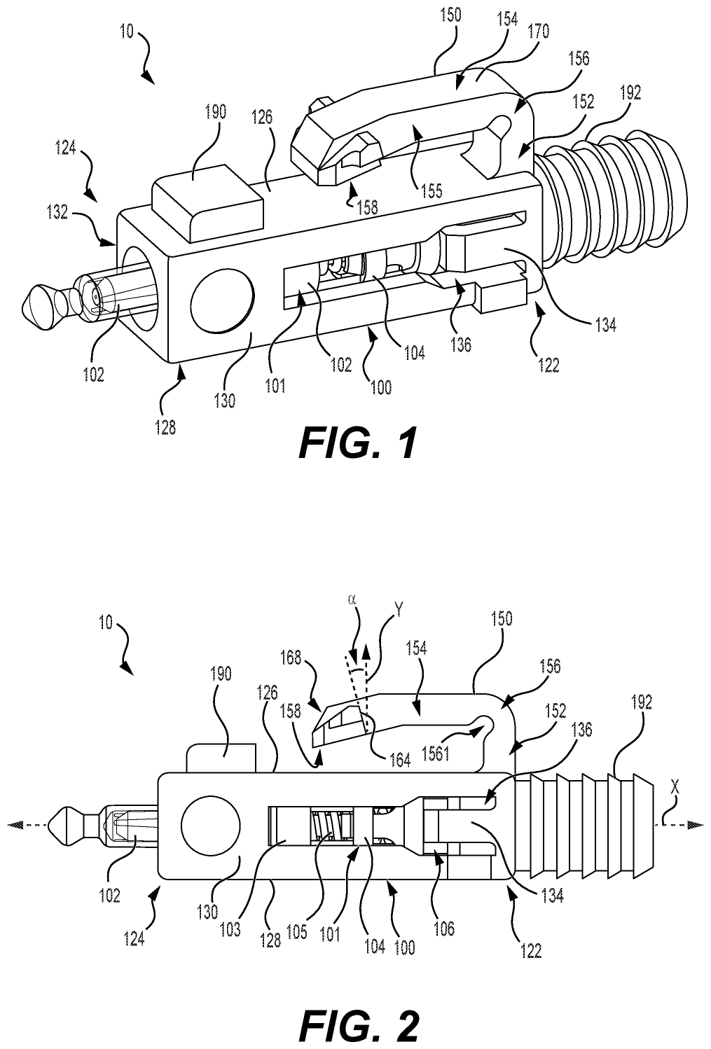

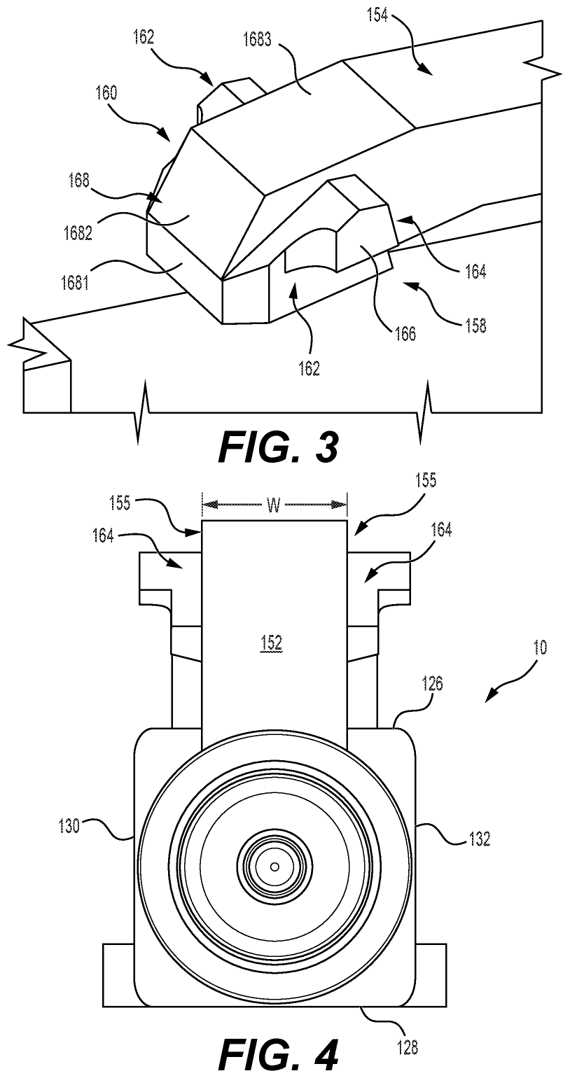

FIGS. 1-4 illustrate an exemplary housing 100 for an optical fiber connector 10 in accordance with various aspects of the disclosure. The housing 100 includes a body portion 120 and a latching portion 150. As best shown in FIGS. 1 and 4, the body portion 120 comprises a square shape when viewed in a longitudinal direction along an axis X of the housing 100 from a first end 122 or a second end 124 of the body portion 120. The body portion 120 includes four exterior walls, including a first wall or top wall 126, a second wall or bottom wall 128 opposite to the first wall 126, and third and fourth walls or side walls 130, 132 extending from the first wall 126 to the second wall 128.

The latching portion 150 extends from the first wail 126 at or proximate the first end 122 of the body portion 120. The latching portion 150 includes a first portion 152 that extends substantially perpendicularly from the first wall 126 and a second portion 154 that extends in the longitudinal direction from the first end 122 toward the second end 124 of the body portion 120. The latching portion 150 further includes a third portion or bend portion 156 between the first portion 152 and the second portion 154. The bend portion 156 includes a notch or notched portion 1561 at the inside of the bend of the bend portion 156. The second portion 154 extends from the third portion 156 and terminates at a free end 158.

As best illustrated in FIG. 4, the first portion 152 and the third portion 156 of the latching portion 150 have a width W in a direction transverse to the longitudinal direction. The second portion 154 also the same width W between side walls 155 of the second portion 154, but the second portion 154 includes additional features proximate the free end 158 that have widths that are greater than the width W, as discussed in more detail below.

For example, the second portion 154 includes an engagement portion 160 that extends from a side wall 155 of the second portion 154. In some aspects, the engagement portion 160 includes engagement structures 162 that extend from the side walls 155 in opposite directions. The engagement structures 162 include an engagement surface 164 that faces in first direction toward the first end 122 of the body portion 120. The engagement surface 164 is configured to form an angle α relative to a vertical axis Y that is perpendicular to the longitudinal axis X of the housing 120. The angle α can be selected based on a desired force required to disengage the engagement portion 160 from an engagement feature of a receptacle, as discussed in more detail below.

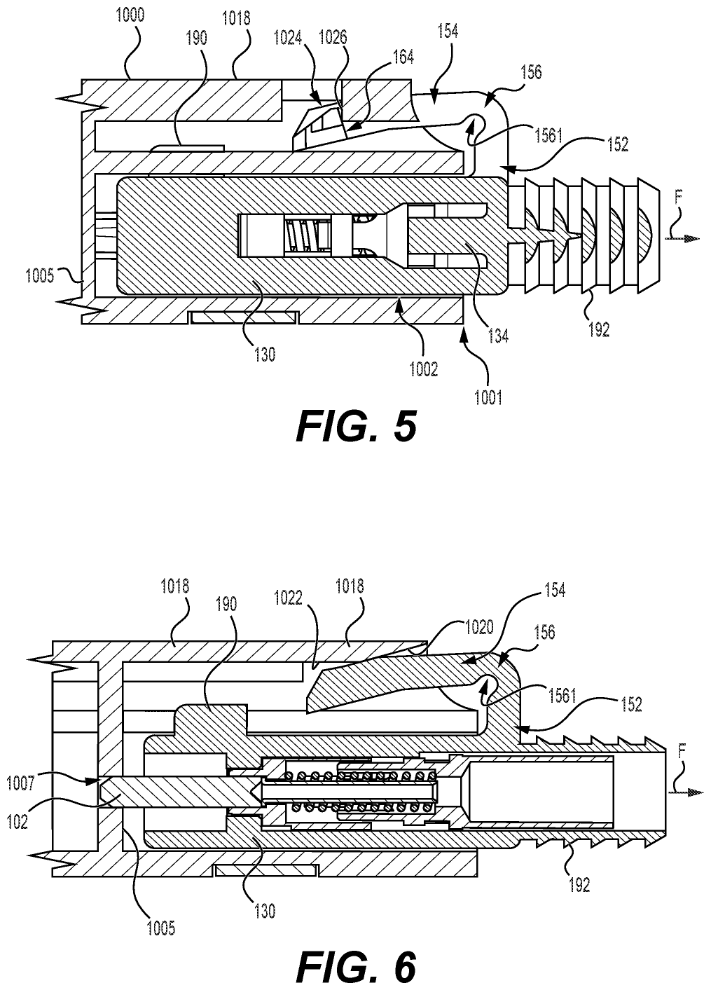

The latching portion 150 is configured to be flexible in the vertical direction such that the second portion 154 of the latching portion 150 can move toward and away from the body portion 120. For example, the second portion 154 can be moved toward the body portion 120 by manually depressing a surface 170, for example, an actuating surface or top surface, of the second portion 154 or by engaging the surface 170 of the second portion 154 with an engagement feature that is stiffer than the latching portion 150. An example of such an engagement feature is discussed below with reference to FIGS. 5-8.

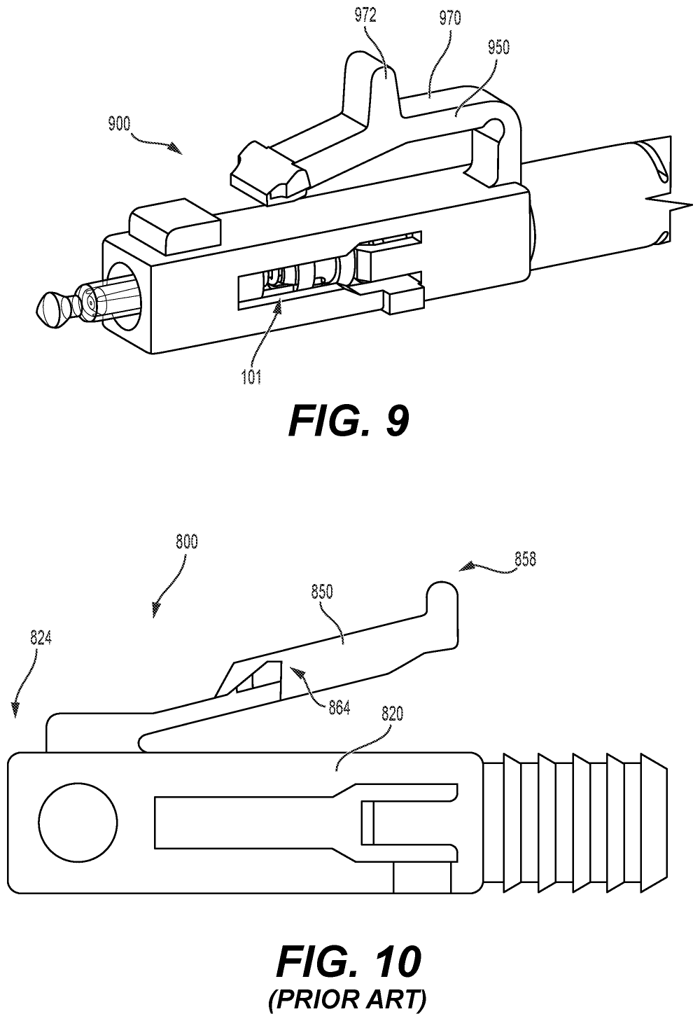

Referring to FIG. 9, in some embodiments of a housing 900 for an optical fiber connector, a latching portion 950 may include an engagement structure 972, for example, a protrusion, ridge, or hump, that extends from a surface 970 of the latching portion 950. The engagement structure 972 may facilitate manual actuation of the latching portion 950 by a user, as would be understood by persons skilled in the art.

Referring again to FIGS. 1 and 2, the housing 100 is configured to be coupled with a sub-assembly 101 of the optical fiber connector 10. The sub-assembly 101 may include a ferrule 102, a ferrule holder 103 configured to receive the ferrule 102, a ferrule holder carrier 104 configured to receive a portion of the ferrule holder 103, and a biasing member 105, for example, a spring, disposed between the ferrule holder 103 and the ferrule holder carrier 104 and configured to permit relative axial movement between the ferrule holder 103 and the ferrule holder carrier 104.

As shown in FIG. 2, the body portion 120 of the housing 100 includes an engagement structure or latch portion 134, for example, a flexible finger, that is configured to be received by an engagement feature 106, for example, an annular groove, in the ferrule holder carrier 104. As illustrated, the side wall 130 may include an opening 136, for example, a cutout or window, and the engagement structure 134 may extend from the first end 122 into the opening 136. The engagement structure 134 may be cantilevered such that the engagement structure 134 can flex inward and outward in a direction transverse to the longitudinal direction. For example, the engagement structure 134 may be urged outward during insertion of the sub-assembly 101 into the housing 100 before being biased inwardly into the engagement feature 106 to couple the housing 100 with the sub-assembly 101. It should be understood that the opposite side wall 132 may include the same engagement structure such that the housing 100 is configured to be coupled with the sub-assembly from opposite sides of the body portion 120.

The housing 100 may include a guiding portion 190, for example, a projection, extending from the first wall 126 of the body portion 120 between the free end 158 of the second portion 154 and the second end 124 of the body portion 120 in the longitudinal direction. The guiding portion 190 is configured to facilitate insertion of the housing 100 into a receptacle, as would be understood by persons skilled in the art.

The housing 100 may also include a receiving portion 192, for example, a barbed portion, extending from the first end 122 of the body portion 120 in a direction away from the second end 124 in the longitudinal direction. The receiving portion 192 may be configured to receive a boot (not shown) that provides strain relief to a fiber optic cable (not shown) terminated by the connector 10.

Referring now to FIGS. 5-8, the housing 100 is configured to be received in a fiber optic receptacle 1000, for example, a fiber optic adapter, a fiber optic port of a transceiver, or the like. The receptacle 1000 includes a receiving portion 1002 configured to receive the housing 100 at a first end 1001 of the receptacle 1000. The receiving portion 1002 may be configured as a contoured cavity or bore having a first portion 1004 having a square shape and sized to the accommodate the body portion 120 and a second portion 1006 configured to receive the latching portion 150. An end wall 1005 of the receiving portion 1002 that is opposite to the first end 1001 includes a receiving feature 1007, for example, an opening or through hole, that is configured to receive the ferrule 102 of the connector sub-assembly 101 so that the ferrule 102 can be optically coupled with a ferrule of another optical fiber component, for example, an optical fiber connector.

As best shown in FIG. 8, a wall 1008 between the first portion 1004 and the second portion 1006 of the receiving portion 1002 includes two wall portions 1010 spaced apart in a direction transverse to the longitudinal direction so as to permit the first portion 152 of the latching portion 150 to pass through an opening 1012 between the two wall portions 1010. The opening 1012 is also sized to accommodate the guiding portion 190 of the housing 100 when the housing 100 is inserted into the receiving portion 1002 of the receptacle 1000.

When viewed from the first end 1001 of the receptacle 1000, as illustrated in FIG. 8, the second portion 1006 of the receiving portion 1002 may be configured as an inverted T shape cavity or bore having a first, horizontal portion 1014 and a second, vertical portion 1016. The vertical portion 1016 of the second portion 1006 has a width that is greater than the width W of the first portion 152 and the third portion 156 of the latching portion and the width W between the side walls 155 of the second portion 154. As a result, the first portion 152, the third portion 156, and the portion of the second portion between the side walls 155 can be slidingly received in the second portion 1006 of the receiving portion 1002 of the receptacle 1000. However, the width of the vertical portion 1016 is less than a width W2 that extends between outer lateral sides 166 of the engagement structures 162 such that the engagement structures 162 are not permitted to be slidingly received in the vertical portion 1016. On the other hand, the horizontal portion 1014 has a width that is greater than the width W2 that extends between outer lateral sides 166 of the engagement structures 162 of the engagement portion 160. As a result, the engagement structures 162 are permitted to be slidingly received in the horizontal portion 1014.

In order to be inserted into the receiving portion 1002 of the receptacle 1000, the latching portion 150 of the housing 100 needs to be urged toward the body portion 120 so that the engagement portion 160 becomes aligned with the horizontal portion 1014 of the receiving portion 1002. Referring again to FIGS. 1-3, the second portion 154 of the latching portion 150 includes an angled surface portion or engagement portion 168. The angled surface portion 168 defines an angle relative to the longitudinal axis X. As shown, the angled surface portion 168 includes a first angled portion 1681 at the free end of the second portion 154, a second angled portion 1682 extending from the first angled portion 1681 toward the third portion 156, and a third angled portion 1683 extending from the second angled portion 1682 toward the third portion 156. As illustrated, the first angled portion 1681 forms an angle with the longitudinal axis X that is steeper than an angle formed by the second angled portion 1682, and the second angle portion forms an angle that is steeper than an angle formed by the third angled portion 1683. It should be understood that the angled surface portion 168 may include more or less than three angled portions, provided that the angled surface portion 168 is configured to facilitate an urging of the latching portion 150 toward the body portion 120 when the housing 100 is inserted into the receiving portion 1002 of the receptacle 1000.

A wall 1018 of the vertical portion 1016 of the receiving portion 1002 may include an angled surface portion 1020 that extends from the first end 1001 of the receptacle 1000 toward the end wall 1005 of the receiving portion 1002. The angled surface portion 1020 is configured to engage the angled surface portion 168 to facilitate the urging of the latching portion 150 toward the body portion 120 when the housing 100 is inserted into the receiving portion 1002 of the receptacle 1000. An inner surface portion 1022 of the wall 1018 may extend from the angled surface portion 1020 in a direction toward the end wall 1005 that is substantially parallel with the longitudinal axis X, and the width of the inner surface portion 1022 may be the same as the width of the vertical portion 1016 of the second portion 1006.

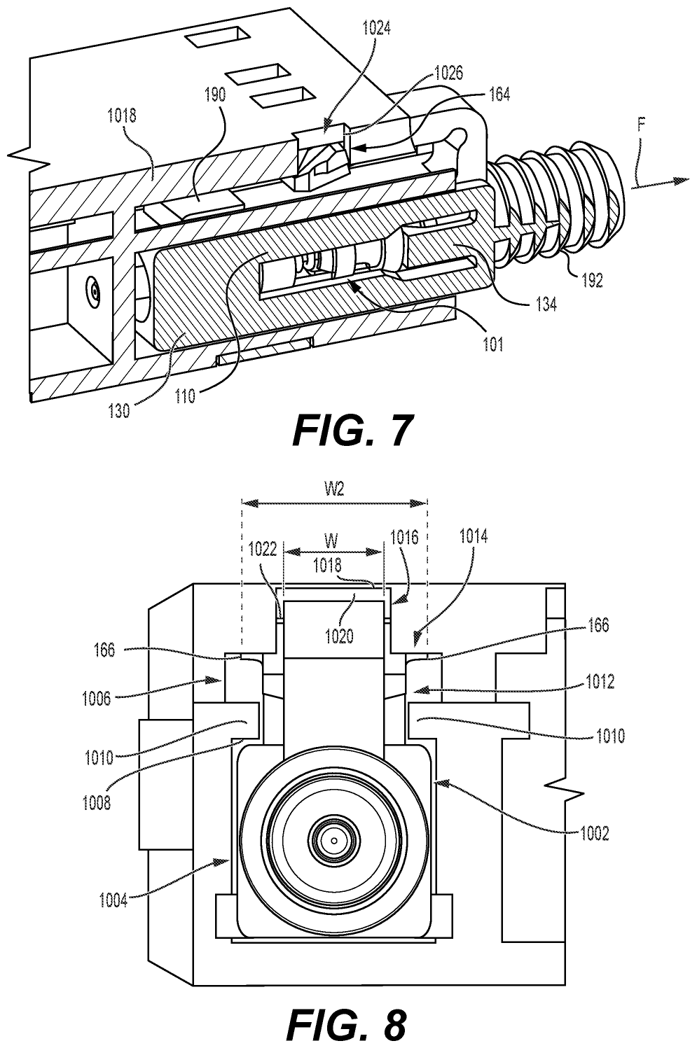

As best shown in FIG. 7, the wall 1018 of the vertical portion 1016 includes an engagement feature 1024, for example, a notch or cutout, that is configured to receive the engagement portion 160 of the latching portion 150 of the housing 100. As best illustrated in FIGS. 5 and 7, the engagement feature 1024 extends from the vertical portion 1016 of the receiving portion 1002 in a direction transverse to the longitudinal axis X. The engagement feature 1024 includes an engagement surface 1026 facing the end wall 1005 of the receiving portion; i.e., facing a direction opposite to the first end 1001 of the receptacle 1000. The engagement feature 1024 extends further toward the horizontal portion 1014 of the receiving portion 1002 than the inner surface portion 1022 of the wall 1018.

As shown in FIGS. 5-8, in use, the second end 124 of the body portion 120 of the housing 100 is aligned with and inserted into the first portion 1004 of the receiving portion 1002 of the receptacle 1000 in a first direction toward the end wall 1005. The guiding portion 190 is aligned with the opening 1012 between the two wall portions 1010 to permit the body portion 120 to slide into the first portion 1004 in the first direction. Eventually, the angled surface portion 168 at the free end 158 of the latching portion 150 comes into contact with the first end 1001 of the receptacle 1000.

As a result of the first end 1001 of the receptacle 1000 and the wall 1018 of the vertical portion 1016, including the angled surface portion 1020, being stiffer or more rigid than the second portion 154 of the latching portion 150 (i.e., the latching portion 150 is more flexible than the wall 1018, the second portion 154 is urged toward the body portion 120 as the housing 100 is slid further into the receiving portion 1002 in the first direction. The second portion 154 is urged toward the body portion 120 until the engagement structures 162 are aligned with and can be slid through the horizontal portion 1014 of the second portion 1006 of the receiving portion 1002 of the receptacle 1000 in the first direction. The housing 100 is further slid in the first direction into the receiving portion 1002 until the engagement structures 162 of the latching portion 150 reach the engagement feature 1024 of the receiving portion 1002. The bias of the latching portion 150 away from the body portion 120 urges the latching portion 150 away from the body portion 120 such that the engagement structures 162 come into contact with engagement surface 1026 of the receiving portion 1002 to achieve a latched configuration of the housing 100 relative to the receptacle 1000. In the latched configuration, the ferrule is configured to extend through the opening in the end wall 1005. It should be understood that the latching portion 150 may be biased toward the body portion 120 by the angled surface portion 1020 when the engagement structures 162 are in contact with engagement surface 1026 of the receiving portion 1002 in the latched configuration.

In normal operation, the connector 10 can be removed from the latched configuration with the receptacle 1000 by applying a force to the actuating surface 170 of the second portion 154 of the latching portion 150 to urge the latching portion 150 toward the body portion 120 until the engagement structures 162 are aligned with and can be slid in a second direction, opposite to the first direction, through the horizontal portion 1014 of the second portion 1006 of the receiving portion 1002 of the receptacle 1000. The housing 100 can then be slid in the second direction until the connector 10 is removed from the receptacle 1000 via the first end 1001.

However, in some situations, the housing 100 may be subjected to an inadvertent or accidental pulling force Fin the second direction relative to the receptacle 1000. For example, a fiber optic cable terminated with the connector 10 may be pulled in the second direction by a person tripping on the fiber optic cable or by some other inadvertently pulling of the fiber optic cable. Or the fiber optic cable may be secured to a structure, and the receptacle 1000 may be pulled in a direction away from the cable, whether inadvertently or otherwise.

In order to prevent damage to the connector 10, the receptacle 1000, and/or a fiber terminated with the connector 10, the housing 100 is configured to release from the receptacle 1000 in response to the inadvertent or accidental pulling force F; that is, without manually depressing the actuating surface 170 of the second portion 154. For example, the latching portion 150 is designed to be sufficiently flexible relative to the body portion 120 such that the latching portion 150 is urged toward the body portion 120 by the contact between the engagement structures 162 and the engagement surface 1026 in response to the pulling force F until the engagement structures 162 disengage from the engagement surface 1026 and are aligned with and can be slid in a second direction, opposite to the first direction, through the horizontal portion 1014 of the second portion 1006 of the receiving portion 1002 and the housing 100 slides out the first end 1001 of the receptacle 1000.

In some embodiments, the engagement structures 162 are configured to disengage from the engagement surface 1026 to de-latch the latching portion 150 from the receptacle 1000 and the housing 120 slides out the first end 1001 of the receptacle 1000 in response to a pulling force F greater than 5 N, or in some embodiments a pulling force F of greater than 20 N, or is some embodiments a pulling force F greater than 50 N.

It should be appreciated the housing can be configured such that any desired predetermined pulling force F is required to disengage the engagement structures 162 from the engagement surface 1026 to de-latch the latching portion 150 from the receptacle 1000 and permit the housing 120 to slide out the first end 1001 of the receptacle 1000. For example, the size of the notch portion 1561 of the third portion 156 of the latching portion 150 can be increased to make the latching portion 150 more flexible relative to the body portion 120, thus reducing the force F required to de-latch the latching portion 150 from the receptacle 1000. Conversely, the size of the notch portion 1561 of the third portion 156 of the latching portion 150 can be decreased to make the latching portion 150 less flexible relative to the body portion 120, thus increasing the force F required to de-latch the latching portion 150 from the receptacle 1000.

Additionally or alternatively, the angle α that the engagement surface 164 forms relative to the vertical axis Y can be configured such that any desired predetermined pulling force F is required to disengage the engagement structures 162 from the engagement surface 1026 to de-latch the latching portion 150 from the receptacle 1000 and permit the housing 120 to slide out the first end 1001 of the receptacle 1000. For example, as the angle α is increased, the force F required to de-latch the latching portion 150 from the receptacle 1000 decreases, and as the angle α is decreased, the force F required to de-latch the latching portion 150 from the receptacle 1000 increases.

In one example, a predetermined pulling force of 5 N or greater is required to de-latch the latching portion 150 from the receptacle at an angle of 15°. In another example, a predetermined pulling force of 20 N or greater is required to de-latch the latching portion 150 from the receptacle at an angle of 0°. In another example, a predetermined puffing force of 50 N or greater is required to de-latch the latching portion 150 from the receptacle 1000. It should be understood that the predetermined pulling force required for the engagement surface to be urged toward the body portion by the engagement feature is inversely proportional to the relative flexibility between the latching portion and the body portion and to the angle formed by the engagement surface.

Further, comparing the housing 100 with the prior art housing 800, the latching portion 150 extends from the body portion 120 proximate the first end 122, while the latching portion 850 extends from the body portion 820 proximate an opposite end. As a result, when a force is applied to the top surface of the latching portion 150, the engagement surface 164 is moved away from the engagement surface 1026. On the other hand, when a force is applied to the top surface of the latching portion 850, the engagement surface 864 is initially moved toward the engagement surface 1026. As a result, the directional movement of the latching portion 150 is configured to assist with de-latching of the latching portion 150 from the receptacle 1000, whereas the opposite directional movement of the latching portion 850 initially inhibits de-latching of the latching portion 850 from the receptacle 1000 until a greater force is applied to move the engagement surface 864 past the engagement surface 1026.

While at least one exemplary, non-limiting embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A housing for an optical fiber connector that releases from a receptacle to prevent damage to the connector, the receptacle, and/or a fiber terminated by the connector in response to a pulling force comprising:
a body portion configured to be received by an optical fiber receptacle;
a latching portion configured to extend from a wall of the body portion proximate a first end of the body portion;
wherein the latching portion includes a first portion that is configured to extend substantially perpendicularly from the wall of the body, a second portion that is configured to extend in a longitudinal direction from the first end of the body portion toward the second end of the body portion, and a third portion that connects the first portion and the second portion;
wherein the third portion comprises a bend portion that is configured to include a notched portion at an inside of a bend of the bend portion;
wherein the second portion is configured to extend from the third portion and terminates at a free end;
wherein the latching portion is configured to flex relative to the body portion in directions toward and away from the body portion;
wherein a flexibility of the latching portion relative to the body portion is configured to be proportional to a size of the notched portion;
wherein the second end of the body portion is configured to be slidingly received in a receiving portion of an optical fiber receptacle via a first end of the receptacle;
wherein the free end of the latching portion is configured to contact an inner surface of a wall of the receptacle and to be urged toward the body portion by the inner surface of the wall such that the latching portion is configured to be slidingly received in the receiving portion of the receptacle;
wherein the second portion of the latching portion includes an engagement portion configured to engage an engagement feature of the receiving portion of the receptacle to latch the housing to the receptacle;
wherein the engagement portion is configured to include an engagement surface that is configured to face in a first direction toward the first end of the body portion and toward an engagement surface of the engagement feature that is configured to face in a second direction opposite to the first direction;
wherein the engagement surface is configured to form an angle relative to an axis that is perpendicular to the wall of the body portion;
wherein the engagement surface is configured to be urged toward the body portion by the engagement feature in response to a predetermined pulling force applied to the housing in a direction away from the first end of the receptacle to de-latch the housing from the receptacle such that the housing is slidingly removed from the receptacle without manually operating the latching portion so as to prevent damage to the connector, the receptacle, and/or a fiber terminated by the connector; and
wherein the predetermined pulling force required for the engagement surface to be urged toward the body portion by the engagement feature is inversely proportional to the relative flexibility between the latching portion and the body portion and to the angle formed by the engagement surface.

2. The housing of claim 1, wherein the predetermined pulling force is 5 N or greater and the angle is 15° or greater.

3. The housing of claim 1, wherein the predetermined pulling force is 20 N or greater and the angle is 0° or greater.

4. The housing of claim 1, wherein the predetermined pulling force is 50 N or greater.

5. A housing for an optical fiber connector that releases from a receptacle to prevent damage to the connector, the receptacle, and/or a fiber terminated by the connector in response to a pulling force comprising:
a body portion configured to be received by an optical fiber receptacle;
a latching portion configured to extend from a wall of the body portion proximate a first end of the body portion;
wherein the latching portion includes a first portion that is configured to extend substantially perpendicularly from the wall of the body, a second portion that is configured to extend in a longitudinal direction from the first end of the body portion toward a second end of the body portion, and a third portion that connects the first portion and the second portion;
wherein the latching portion is configured to flex relative to the body portion in directions toward and away from the body portion;
wherein the second end of the body portion is configured to be slidingly received in a receiving portion of an optical fiber receptacle via a first end of the receptacle;
wherein the latching portion is configured to be urged toward the body portion by the receiving portion such that the latching portion is configured to be slidingly received in the receiving portion of the receptacle;
wherein the second portion of the latching portion includes an engagement portion configured to engage an engagement feature of the receiving portion of the receptacle to latch the housing to the receptacle; and
wherein the engagement portion is configured to be urged toward the body portion by the engagement feature in response to a predetermined pulling force applied to the housing in a direction away from the first end of the receptacle to de-latch the housing from the receptacle such that the housing is slidingly removed from the receptacle without manually operating the latching portion so as to prevent damage to the connector, the receptacle, and/or a fiber terminated by the connector.

6. The housing of claim 5, wherein the third portion comprises a bend portion that is configured to include a notched portion at an inside of a bend of the bend portion.

7. The housing of claim 6, wherein a flexibility of the latching portion relative to the body portion is configured to be proportional to a size of the notched portion.

8. The housing of claim 7, wherein the predetermined pulling force required for the engagement surface to be urged toward the body portion by the engagement feature is inversely proportional to the relative flexibility between the latching portion and the body portion.

9. The housing of claim 5, wherein the engagement portion is configured to include an engagement surface that is configured to face in a first direction toward the first end of the body portion and toward an engagement surface of the engagement feature that is configured to face in a second direction opposite to the first direction.

10. The housing of claim 9, wherein the engagement surface is configured to form an angle relative to an axis that is perpendicular to the wall of the body portion.

11. The housing of claim 10, wherein the predetermined pulling force required for the engagement surface to be urged toward the body portion by the engagement feature is inversely proportional to the angle formed by the engagement surface.

12. The housing of claim 5, wherein the second portion is configured to extend from the third portion and terminates at a free end.

13. The housing of claim 12, wherein the free end of the latching portion is configured to be urged toward the body portion by the inner surface of the receiving portion such that the latching portion is configured to be slidingly received in the receiving portion of the receptacle.

14. The housing of claim 5, wherein the predetermined pulling force is 5 N or greater and the angle is 15° or greater.

15. The housing of claim 5, wherein the predetermined pulling force is 20 N or greater and the angle is 0° or greater.

16. The housing of claim 5, wherein the predetermined pulling force is 50 N or greater.

17. A housing for an optical fiber connector that releases from a receptacle to prevent damage to the connector, the receptacle, and/or a fiber terminated by the connector in response to a pulling force comprising:
a body portion configured to be received by an optical fiber receptacle;
a latching portion configured to extend from the body portion proximate a first end of the body portion;
wherein the body portion and the latching portion are configured to be slidingly received in an optical fiber receptacle via a first end of the receptacle; and
wherein the latching portion is configured to be urged toward the body portion by the receptacle in response to a predetermined pulling force applied to the housing in a direction away from the first end of the receptacle to de-latch the housing from the receptacle such that the housing is slidingly removed from the receptacle without manually operating the latching portion so as to prevent damage to the connector, the receptacle, and/or a fiber terminated by the connector.

18. The housing of claim 17, wherein the latching portion is configured to flex relative to the body portion in directions toward and away from the body portion.

19. The housing of claim 17, wherein the latching portion includes a first portion that is configured to extend substantially perpendicularly from the wall of the body, a second portion that is configured to extend in a longitudinal direction from the first end of the body portion toward a second end of the body portion, and a third portion that connects the first portion and the second portion.

20. The housing of claim 19, wherein the third portion comprises a bend portion that is configured to include a notched portion at an inside of a bend of the bend portion.

21. The housing of claim 20, wherein a flexibility of the latching portion relative to the body portion is configured to be proportional to a size of the notched portion.

22. The housing of claim 21, wherein the predetermined pulling force required for the latching portion to be urged toward the body portion is inversely proportional to the relative flexibility between the latching portion and the body portion.

23. The housing of claim 17, wherein the latching portion includes an engagement portion configured to engage an engagement feature of the receiving portion of the receptacle to latch the housing to the receptacle.

24. The housing of claim 23, wherein the engagement portion is configured to include an engagement surface that is configured to face in a first direction toward the first end of the body portion and toward an engagement surface of the engagement feature that is configured to face in a second direction opposite to the first direction.

25. The housing of claim 24, wherein the engagement surface is configured to form an angle relative to an axis that is perpendicular to the wall of the body portion.

26. The housing of claim 25, wherein the predetermined pulling force required for the engagement surface to be urged toward the body portion by the engagement feature is inversely proportional to the angle formed by the engagement surface.

27. The housing of claim 17, wherein the latching portion is configured to be urged toward the body portion by a receiving portion of the receptacle such that the latching portion is configured to be slidingly received in the receiving portion of the receptacle.

28. The housing of claim 17, wherein the second portion is configured to extend from the third portion and terminates at a free end.

29. The housing of claim 28, wherein the free end of the latching portion is configured to be urged toward the body portion by the inner surface of the receiving portion such that the latching portion is configured to be slidingly received in the receiving portion of the receptacle.

30. The housing of claim 17, wherein the predetermined pulling force is 5 N or greater and the angle is 15° or greater.

31. The housing of claim 17, wherein the predetermined pulling force is 20 N or greater and the angle is 0° or greater.

32. The housing of claim 17, wherein the predetermined pulling force is 50 N or greater.
